(19) United States
(12) Patent Application Publication
(10) Pub. No.: US 2023/0419137 A1
(43) Pub. Date: Dec. 28, 2023

(54) GLOBAL CONTEXT EXPLAINERS FOR ARTIFICIAL INTELLIGENCE (AI) SYSTEMS USING MULTIVARIATE TIMESERIES DATA

(71) Applicant: INTERNATIONAL BUSINESS MACHINES CORPORATION, Armonk, NY (US)

(72) Inventors: Vijay ARYA, Gurgaon (IN); Diptikalyan SAHA, Bangalore (IN); Amaresh RAJASEKHARAN, Wappingers Falls, NY (US); Shengrong TANG, Dublin, OH (US)

(21) Appl. No.: 17/808,927

(22) Filed: Jun. 24, 2022

(51) Int. Cl. G06N 5/04; G06K 9/62; G06N 20/20

(52) U.S. Cl. CPC G06N 5/045; G06K 9/6257; G06K 9/6262; G06N 20/20

(57) ABSTRACT

Provided are techniques for global context explainers for Artificial Intelligence systems using multivariate timeseries data. Predictions for multivariate timeseries data are received. Feature importance weights are generated from the predictions using a feature-based local explainer, where each of the feature importance weights is associated with a time period and a corresponding data source of timeseries data of the multivariate timeseries data. A dataset is generated using the feature importance weights, where the dataset includes, for each time period and the corresponding data source, a label indicating whether the feature importance weight is one of positive and negative. One or more global explanations are generated using the dataset and a directly interpretable rule-based explainer, where the one or more global explanations indicate how the predictions change at particular times in the multivariate timeseries data based on values from the corresponding data source. An action based on the global explanations is performed.

### BACKGROUND

Embodiments of the invention relate to global context explainers for Artificial Intelligence (AI) systems using multivariate timeseries data. Embodiments of the invention further perform an action in response to global explanations provided by the global context explainers.

Timeseries data may be described as measurements or events that are tracked, monitored, downsampled, and/or aggregated over time. The timeseries data may be for server metrics, application performance monitoring, network data, sensor data, events, clicks, trades in a market, and many other types of analytics data.

With increased focus on instrumentation and observability, timeseries data is ubiquitous and occurs in a broad range of application domains such as healthcare, finance, e-commerce, Information Technology (IT), social media, Internet of Things (IoT), etc.

Deep learning models are used to model the temporal nature of timeseries data for tasks such as: forecasting, prediction, classification, and anomaly detection. Examples of deep learning models include Recurrent Neural Networks (RNNs) and its variants, Long Short-Term Memory (LSTM) models and Gated Recurrent Units (GRUs).

### SUMMARY

In accordance with certain embodiments, a computer-implemented method is provided for global context explainers for Artificial Intelligence (AI) systems using multivariate timeseries data. The computer-implemented method comprises operations of: receiving predictions for multivariate timeseries data; generating feature importance weights from the predictions using a feature-based local explainer, wherein each of the feature importance weights is associated with a time period and a corresponding data source of timeseries data of the multivariate timeseries data; generating a dataset using the feature importance weights, wherein the dataset includes, for each time period and the corresponding data source, a label indicating whether the feature importance weight is one of positive and negative; generating one or more global explanations using the dataset and a directly interpretable rule-based explainer, wherein the one or more global explanations indicate how the predictions change at particular times in the multivariate timeseries data based on values from the corresponding data source; and performing an action based on the global explanations.

In accordance with other embodiments, a computer program product is provided for global context explainers for Artificial Intelligence (AI) systems using multivariate timeseries data. The computer program product comprises a computer readable storage medium having program code embodied therewith, the program code executable by at least one processor to perform operations of: receiving predictions for multivariate timeseries data; generating feature importance weights from the predictions using a feature-based local explainer, wherein each of the feature importance weights is associated with a time period and a corresponding data source of timeseries data of the multivariate timeseries data; generating a dataset using the feature importance weights, wherein the dataset includes, for each time period and the corresponding data source, a label indicating whether the feature importance weight is one of positive and negative; generating one or more global explanations using the dataset and a directly interpretable rule-based explainer, wherein the one or more global explanations indicate how the predictions change at particular times in the multivariate timeseries data based on values from the corresponding data source; and performing an action based on the global explanations.

In accordance with yet other embodiments, a computer system is provided for global context explainers for Artificial Intelligence (AI) systems using multivariate timeseries data. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations of: receiving predictions for multivariate timeseries data; generating feature importance weights from the predictions using a feature-based local explainer, wherein each of the feature importance weights is associated with a time period and a corresponding data source of timeseries data of the multivariate timeseries data; generating a dataset using the feature importance weights, wherein the dataset includes, for each time period and the corresponding data source, a label indicating whether the feature importance weight is one of positive and negative; generating one or more global explanations using the dataset and a directly interpretable rule-based explainer, wherein the one or more global explanations indicate how the predictions change at particular times in the multivariate timeseries data based on values from the corresponding data source; and performing an action based on the global explanations.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates, in a flowchart, operations for generating global explanations and performing an action based on the global explanations in accordance with certain embodiments.

FIGS. 3A and 3B illustrate timeseries in accordance with certain embodiments.

FIG. 4 illustrates timeseries data from a subset of sensors of an engine in accordance with certain embodiments.

FIG. 5 illustrates multivariate timeseries data of run to failure of aircraft engines in accordance with certain embodiments.

FIG. 6 illustrates training and testing data sets in accordance with certain embodiments.

FIG. 7 illustrates true and predicted remaining useful life for one hundred engine units in the test set of fleet FD01 in accordance with certain embodiments.

FIG. 8 illustrates example an example global context and example global explanations in accordance with certain embodiments.

FIG. 9 illustrates interaction of a source ML model and a global context explainer in accordance with certain embodiments.

FIG. 10 illustrates equations in accordance with certain embodiments.

FIG. 11 illustrates a dataset in accordance with certain embodiments.

FIG. 12 illustrates feature importance weights in accordance with certain embodiments.

FIG. 13 illustrates example global explanations for sensors in accordance with certain embodiments.

FIG. 14 illustrates, in a flowchart, operations performed by a global context explainer in accordance with certain embodiments.

FIG. 15 illustrates a computing node in accordance with certain embodiments.

FIG. 16 illustrates a cloud computing environment in accordance with certain embodiments.

FIG. 17 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

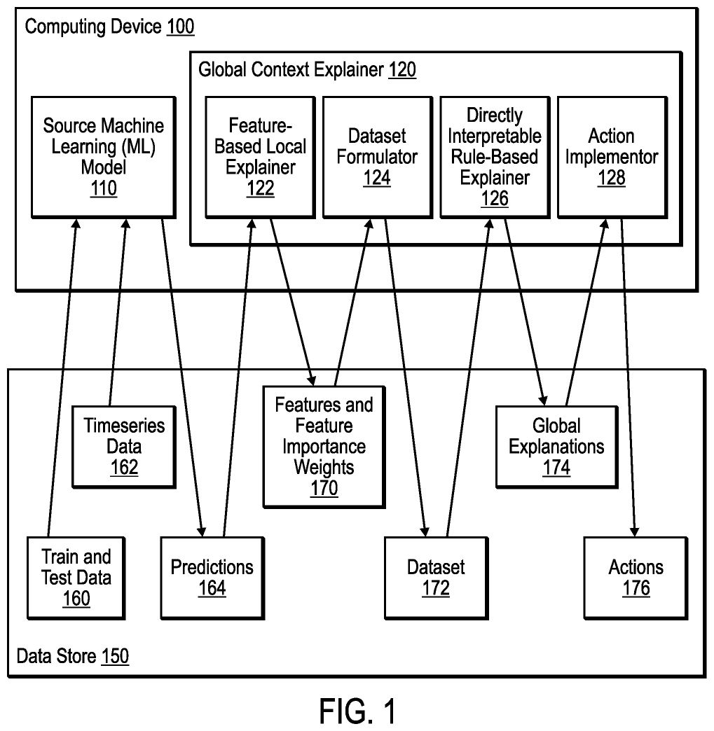

FIG. 1 illustrates, in a block diagram, a computing environment in accordance with certain embodiments. In FIG. 1, a computing device 100 is connected to a data store 150. The computing device 100 includes a machine learning (ML) model 110 and a global context explainer 120. The global context explainer 120 includes a feature-based local explainer 122 (“local explainer” or “feature-based explainer”), a dataset formulator 124, a directly interpretable rule-based explainer 126 (“global explainer” or “rule-based explainer”), and an action implementer 126.

The data store 150 stores train and test data 160, timeseries data 162, predictions 164, feature values 170, a dataset 172, global explanations 174, and actions 176.

In certain embodiments, the feature-based local explainer 122 and the directly interpretable rule-based explainer 126 are machine learning models, which may also described as AI systems. In certain embodiments, the feature-based local explainer 122 may be implemented using Local Interpretable Model-agnostic Explanations (LIME), SHapley Additive exPlanations (SHAP), saliency maps, etc. In certain embodiments, the directly interpretable rule-based explainer 126 may be implemented using Boolean Rules via Column Generation (BRCG), the TREPAN technique, Generalized Linear Rule Models (GLRM), Certifiable Optimal RulE ListS (CORELS), Decision Tree, etc.

In certain embodiments, the global context explainer 120 includes the feature-based local explainer 122 and the directly interpretable rule-based explainer 126 and does not include, but works with, the dataset formulator 124 and the action implementor 128. In certain embodiments, the feature-based local explainer 122 may be described as a first ML model or as a first AI model, while the directly interpretable rule-based explainer 126 may be described as a second ML model or as a second AI model.

In certain embodiments, the global explanations 174 may be described as rules of thumb that indicate behaviour of sources that provided the timeseries data and that may be used while viewing a data instance along with the predictions to understand (and so trust) the predictions. A data instance may be described as one instance of a multivariate timeseries. In certain embodiments, a global explanation 174 may provide a rule and a rule fidelity (i.e., an indication of how often the rule is true for the data).

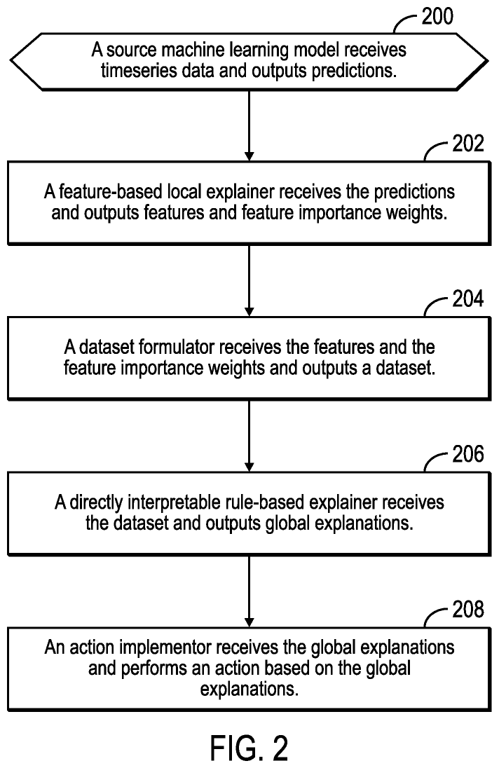

FIG. 2 illustrates, in a flowchart, operations for generating global explanations and performing an action based on the global explanations in accordance with certain embodiments. Control begins at block 200 with the source machine learning model 110 receiving timeseries data 162 and outputting predictions 164. In block 202, the feature-based local explainer 122 receives the predictions 164 and outputs features and feature importance weights 170. In certain embodiments, each feature and associated feature importance weight is associated with a time and a data source (i.e., a source of timeseries data, such as a sensor).

In block 204, the dataset formulator 124 receives the features and the feature importance weights 170 and outputs a dataset 172. In certain embodiments, the dataset provides, for a time, for data from a data source (e.g., a sensor), a label, where the label has a first indicator (e.g., “1”) if the feature importance weight at that time for that data source is positive and has a second indicator (e.g., “0”) if the feature importance weight at that time for that data source is negative. In certain embodiments, the dataset formulator 124 uses the data and explanations from the feature-based local explainer 122 as features/labels to construct the dataset 172. In certain embodiments, the dataset formulator 124 may be described as a supervised ML problem formulator, and the ML problem is to predict the label given the features (e.g., time and data source value). In certain embodiments, the dataset 172 is formulated based on the time, multivariate timeseries data, and computed weights (feature importance weights), where the dataset 172 includes the features of time and values of the multivariate timeseries, the labels that include the feature importance weight and a binary value based on whether the feature importance weight is positive or negative. In other embodiments, the value may be three or more possible values (i.e., is not binary).

In block 206, the directly interpretable rule-based explainer 126 receives the dataset 172 (which may be referred to as a labelled dataset) and outputs global explanations 174. In block 208, the action implementor 128 receives the global explanations 174 and performs an action 176 based on the global explanations 174. In certain embodiments, the action is selected from: modifying a data source, sending a notification, and scheduling maintenance.

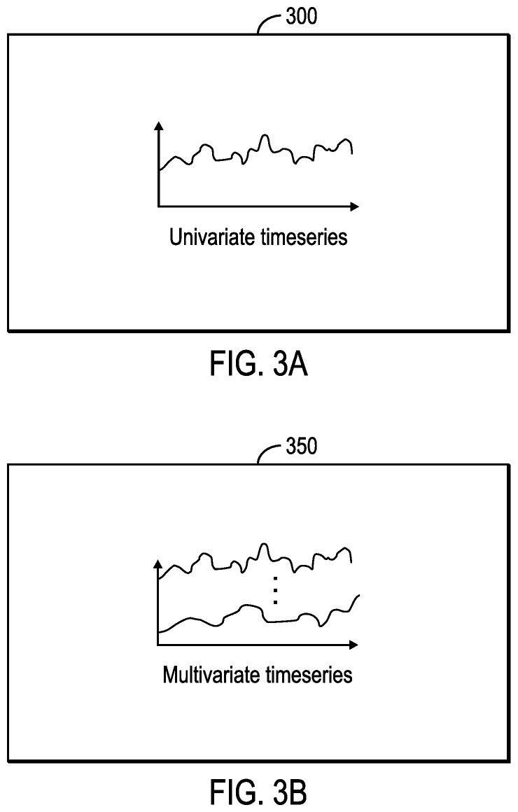

FIGS. 3A and 3B illustrate timeseries data in accordance with certain embodiments. FIG. 3A illustrates univariate timeseries data 300, which is timeseries data from one data source (e.g., one sensor). FIG. 3B illustrates multivariate timeseries data 350, which is timeseries data from multiple data sources (e.g., multiple sensors).

Merely to enhance understanding, examples are provided herein for an AI application involving the prediction of the Remaining Useful Life (RUL) of an aircraft's engine based on timeseries data from multiple sensors (e.g., 21 sensors on the engine). However, embodiments are not limited to this example.

The example herein considers the use case of predicting the RUL of an aircraft's engine given historical measurements from multiple sensors that are fitted on the engine. In certain embodiments, LSTM models or GRUs are used to generate predictions.

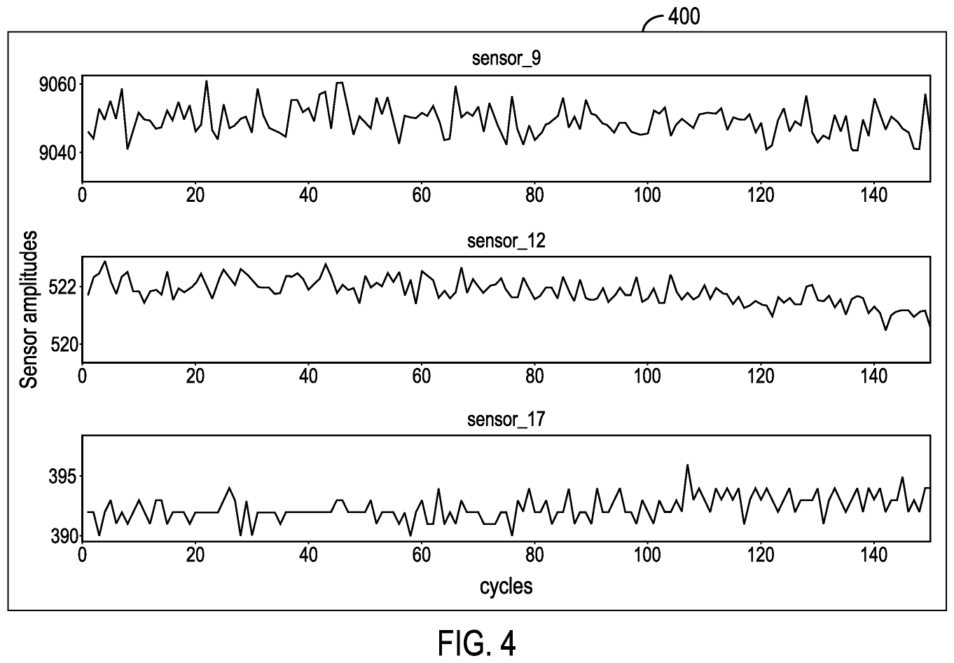

FIG. 4 illustrates timeseries data 400 from a subset of sensors of an engine in accordance with certain embodiments. In FIG. 4, the x-axis represents cycles, and the y-axis represents amplitude of the sensors. FIG. 4 shows timeseries from three sensors of an engine (sensor 9, sensor 12, and sensor 17). Embodiments provide rules and global explanations of the rules used by the AI models to predict the RUL. In addition, if the value of a sensor is increasing over time, embodiments provide an explanation of whether that increase contributes to an increase or decrease of the predicted RUL. Each data instance may have many features (e.g., the number of sensors times the number of cycles).

In certain embodiments, the global context explainer 120 fuses two explainers (the feature-based local explainer 122 and the directly interpretable rule-based explainer 126) in sequence to generate global explanations 174 for multivariate timeseries models. In particular, the output of one explainer is transformed and posed into a supervised machine learning problem so that its explanations may be explained by another explainer.

Embodiments build a two-stage global post-hoc black-box context explainer for the problem of RUL prediction based on multivariate timeseries data. The global context explainer 120 fuses the feature-based local explainer 122 that outputs feature importance weights with a directly interpretable rule-based explainer that outputs global explanations 174.

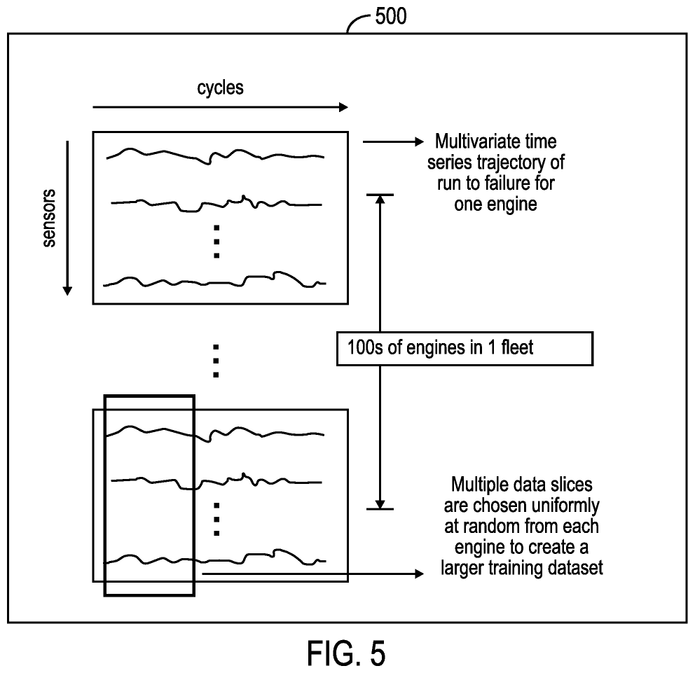

FIG. 5 illustrates multivariate timeseries data 500 of run to failure of aircraft engines in accordance with certain embodiments. In FIG. 5, each engine's data is a multivariate timeseries that consists of measurements taken over time from different sensors fitted on that engine. Each time period corresponds to one operating cycle of the engine. The source ML model 110 predicts the RUL of an aircraft's engine given its current history of sensor measurements.

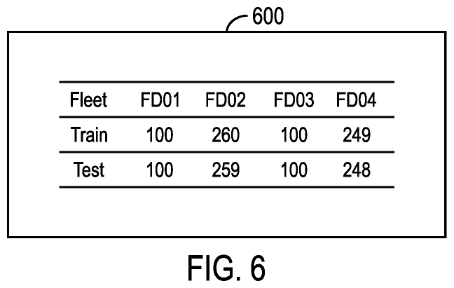

FIG. 6 illustrates training and testing data sets 600 in accordance with certain embodiments. Each engine's data is represented as a multivariate timeseries from multiple sensors and multiple operating modes. In the example of FIG. 6, the dataset 600 has 4 fleets of engines (FD01, FD02, FD04, FD04), with each fleet having approximately an equal number of train instances and test instances. While the train data records the run to failure trajectories, the test data holds the historical sensor measurements of engines until a certain point in time with known remaining useful life.

In certain embodiments, an LSTM model is trained on the dataset, where the LSTM model has 8 layers (2 LSTM, 2 dropout, 1 flatten, and 3 dense layers) and uses data from 7 out of 21 sensors for training (7, 8, 9, 12, 16, 17, and 20). The LSTM model uses an augmented dataset for training, in which multiple slices of data are extracted uniformly at random from each engine's timeseries and appended to the original training dataset. The multivariate timeseries data may be normalized and padded before being fed

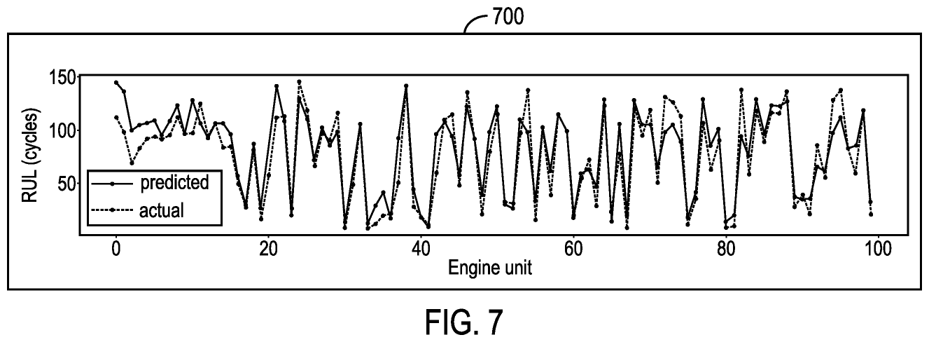

to the LSTM model. FIG. 7 illustrates the true RUL and the RUL predicted by the LSTM model for one hundred (100) engines in the test set of fleet FD01 in accordance with certain embodiments. The LSTM model has high accuracy with a train and test Root Mean Square Error (RMSE) of about 16 and 17 cycles respectively.

The global context explainer 120 may be described as a global black-box post-hoc explainer, which means that it relies on the source ML model's predict function for computing global explanations 174 and does not require knowledge of the source ML model's internals, such loss function or architecture. Therefore, the global context explainer 120 may be used with any AI model.

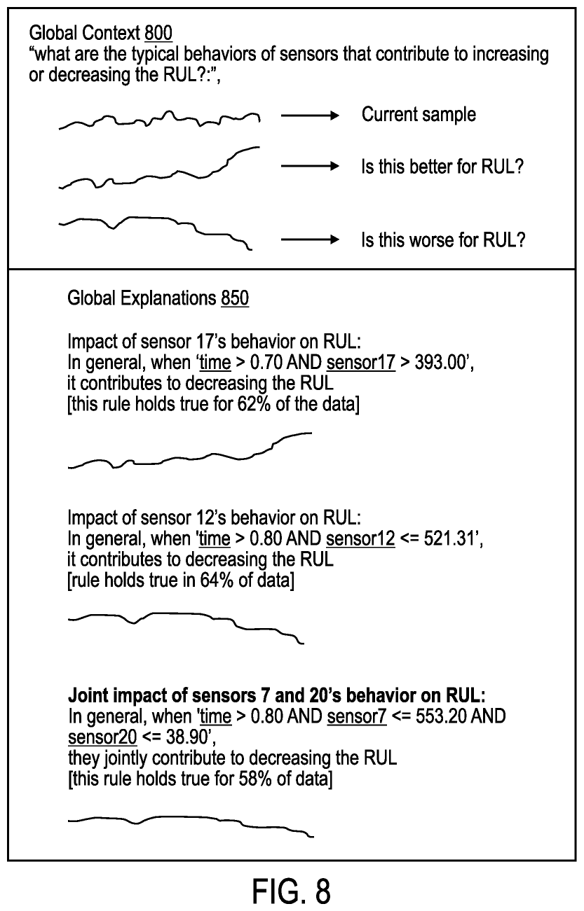

FIG. 8 illustrates example an example global context and example global explanations in accordance with certain embodiments. For a global context of “what are the typical behaviours of sensors that contribute to increasing or decreasing the RUL?:”, the global context explainer 120 determines whether each timeseries from each sensor is better for the RUL or worse for the RUL. The global context explainer 120 provides global explanations 810, 820, 830, which may be described as rules of thumb that may be used while viewing a data instance along with the predicted RUL to better understand the source ML model 110. Such a better understanding of the source ML model 110 may increase trust in the prediction.

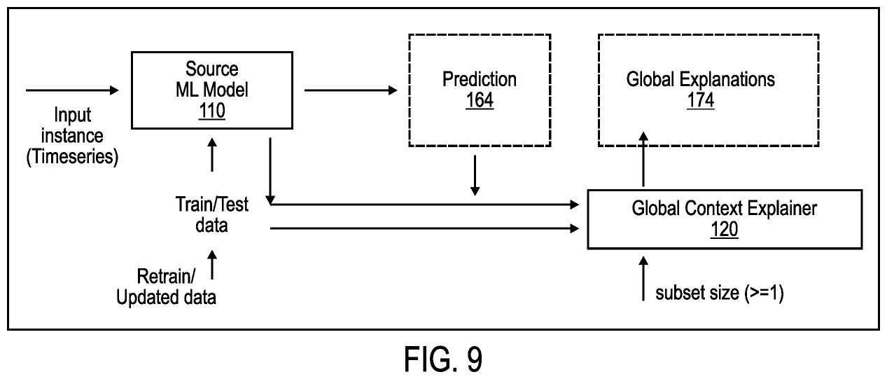

FIG. 9 illustrates interaction of the source ML model 110 and the global context explainer 120 in accordance with certain embodiments. The source ML model 110 receives an input instance (a timeseries) and outputs a prediction 164 (e.g., an RUL). The source ML model is trained and tested with data and retrained and retested with updated data. The global context explainer 120 receives the prediction 162, the train and test data, and may receive an Application Programming Interface (API) of the source ML model 110 or a predict function of the source ML model 110 that provides output labels or probabilities. Then, the global context explainer 120 generates the global explanations 174. With embodiments, the global context explainer 120 receives a parameter K (>=1), where K is the number of sensors used in the explanation (i.e., K represents a subset size).

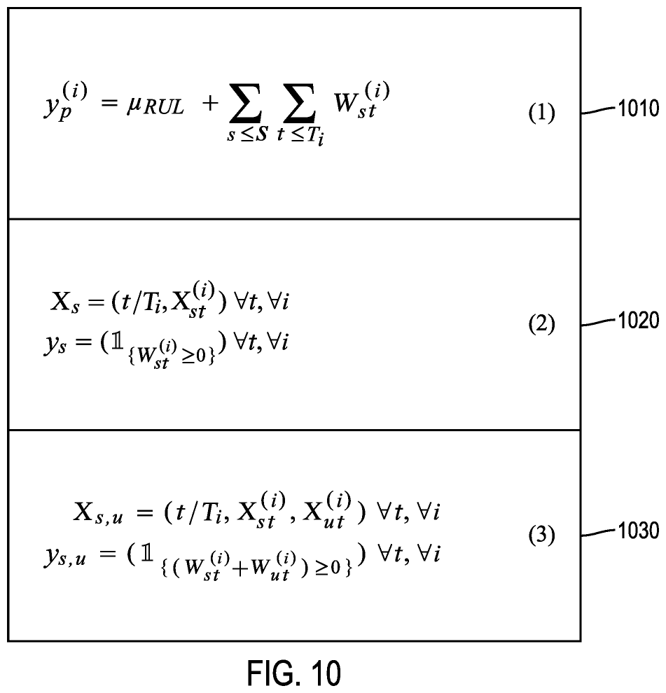

FIG. 10 illustrates equations in accordance with certain embodiments. With embodiments, (X⁽ⁱ⁾, y⁽ⁱ⁾) denote the train dataset. The sample X⁽ⁱ⁾ is the multivariate timeseries data of engine i that has an RUL of y⁽ⁱ⁾. X⁽ⁱ⁾∈R^{S×Ti}, where S denotes the number of sensors and Tᵢ denotes the number of time periods (i.e., cycles) in the timeseries of engine i. Following a matrix notation, the element X⁽ⁱ⁾ₛₜ denotes the amplitude value of sensor s (or other source s) at time period t in data instance i. In addition, (X′⁽ⁱ⁾, y′⁽ⁱ⁾) denotes the test dataset. Given a source ML model F, for which global explanations are to be generated, embodiments use F to compute RUL predictions for train and test data as yₚ⁽ⁱ⁾=F (X⁽ⁱ⁾) and yₚ′⁽ⁱ⁾=F (X′⁽ⁱ⁾), respectively. Embodiments then use (X⁽ⁱ⁾, yₚ⁽ⁱ⁾) to train the global context explainer and (X′⁽ⁱ⁾, yₚ′⁽ⁱ⁾) to test the global context explainer.

In certain embodiments, the feature-based local explainer 122 computes the feature importance weights for the samples in the train predictions data (X⁽ⁱ⁾, yₚ⁽ⁱ⁾). With embodiments, W⁽ⁱ⁾∈R^{s×T}ᵢ denotes a matrix of feature importance weights computed for sample X⁽ⁱ⁾ (i.e., the weight W⁽ⁱ⁾ₛₜ denotes the importance assigned to feature value X⁽ⁱ⁾ₛₜ. In certain embodiments, the feature-based local explainer 122 uses SHAP, which is an additive local explainer and a sample's feature importance weights are related to the prediction per Equation (1) 1010 of FIG. 10.

In Equation (1) 1010, μ_{RUL} is the mean of RUL predictions for samples in the training dataset. Equation (1) 1010 states that each feature's weight pushes the prediction above or below the mean value. Therefore, W⁽ⁱ⁾ₛₜ>0 indicates that the feature value X⁽ⁱ⁾ₛₜ contributes to increasing the RUL, while W⁽ⁱ⁾ₛₜ<0 indicates that X⁽ⁱ⁾ₛₜ contributes to decreasing the RUL. In certain embodiments, W⁽ⁱ⁾ₛₜ=0 does not impact the RUL.

In certain embodiments, the directly interpretable rule-based explainer 128 generates global explanations 174 (insights about the source ML model's global behaviour) from a large matrix of weights W⁽ⁱ⁾. The directly interpretable rule-based explainer 128 generates the global explanations 174 by analysing W⁽ⁱ⁾'s across many (e.g., hundreds of) engines in the example provided herein. For instance, S=7 sensors and Ti=100 time periods, which results in 700 weights for one engine. Embodiments pose a supervised machine learning problem and fit the directly interpretable rule-based explainer 128 to obtain global explanations 174. In particular, the dataset formulator 124 constructs a labelled, tabular dataset Dₛ={Xₛ, yₛ} for each sensor s with Equation (2) 1020.

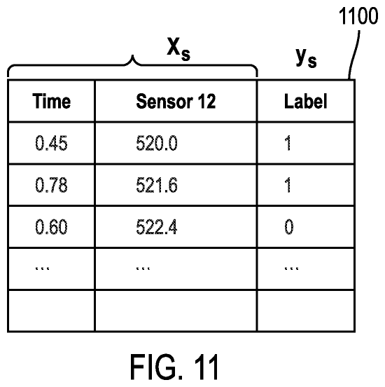

In other words, each sample in Xₛ is a pair of features that includes a time index (e.g., a fractional time) and the value of sensor s at that time index for some engine i. The corresponding binary label in yₛ indicates whether this sensor value contributes a +ve (1) or −ve (0) weight to the predicted RUL of engine i. These sample pairs are collected for the engines i and the time periods t to obtain Dₛ. A normalized value of time index t/Tᵢ is chosen in place of t as the timeseries length varies across engines. FIG. 11 illustrates a dataset 1100 in accordance with certain embodiments. The dataset 1100 indicates a label for a time period for a sensor.

With embodiments, a DI classification model Hₛ is fit on Dₛ to obtain global explanations 174 that explain how values of sensor s at different time indices contribute towards increasing or decreasing the predicted RUL. Construction of Dₛ and Hₛ is repeated for each individual sensor s.

This generates global explanations 174 for individual sensors to understand how the marginal behavior of a sensor over time impacts the RUL prediction. In order to understand how the joint behavior of a group of sensors impacts the RUL prediction, embodiments leverage the fact that SHAP is an additive local explainer (Equation (1) 1010), which means that the importance weights of features may be aggregated to compute their joint importance. Therefore, given two sensors, s and u, the dataset formulator 124 constructs the tabular dataset D_{s,u}={X_{s,u},y_{s,u}} with Equation (3) 1030.

A DI model H_{s,u} is fit on D_{s,u}. Each sample in X_{s,u} contains 3 features, which includes the time index along with values of sensor s and u at that time for some engine i. The global explanations 174 computed by H_{s,u} explain how the joint behavior of s and u over time impacts RUL prediction.

In certain embodiments, the directly interpretable rule-based explainer 128 is implemented with a BRCG explainer. Then, given a labelled dataset, the directly interpretable rule-based explainer 128 computes a classification model as a set of Boolean rules on features either in disjunctive or conjunctive normal form.

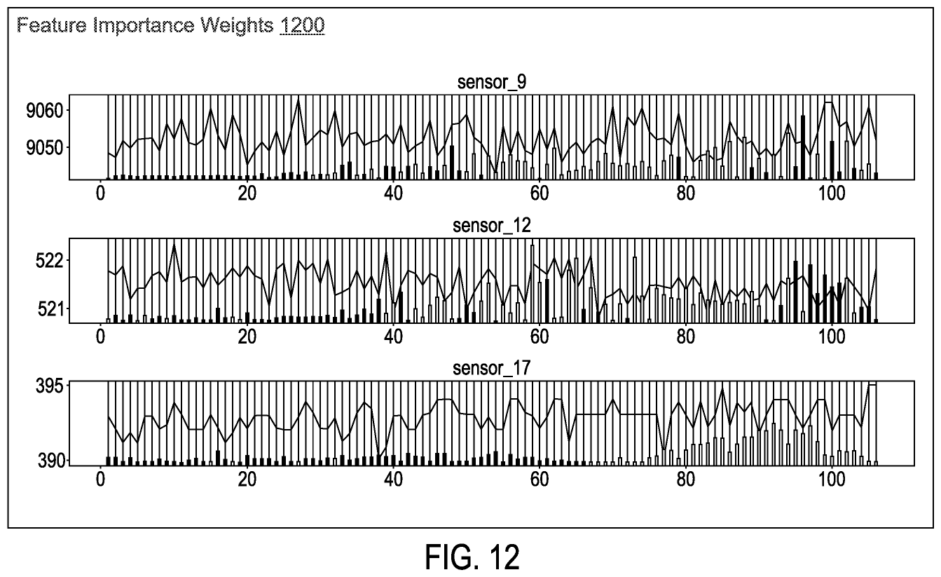

FIG. 12 illustrates feature importance weights 1200 in accordance with certain embodiments. In FIG. 12, the sensor values (curves) are plotted along with feature importance weights (vertical bars) for sensors 9, 12, and 17. The +ve weights are shown as white bars, while −ve weights are shown as black bars (where the bars are normalized by the height of the y-axis).

In certain embodiments, the directly interpretable rule-based explainer 128 is fit by constructing the datasets Dₛ for individual and groups of sensors. The directly interpretable rule-based explainer 128 computes a set of rules that jointly yield the best training accuracy. To minimize the complexity of global explanations, the directly interpretable rule-based explainer 128 may select an individual global explanation 174 that has the highest fidelity (i.e., faithfulness) on the test data.

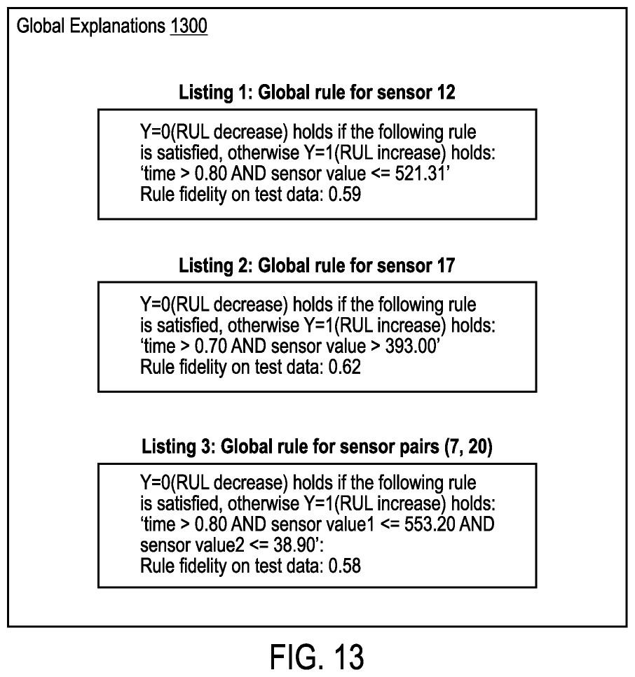

FIG. 13 illustrates example global explanations 1300 for sensor 12, sensor 17, and the combination if sensors 7 and 20 in accordance with certain embodiments. The global rules computed by the DI models H₁₂, H₁₇, and H_{7,20} are shown corresponding to sensors 12, 17, and the pair of sensors (7, 20), respectively.

In FIG. 13, the directly interpretable rule-based explainer 128 explains that the impact of sensor 17's behavior on RUL indicates that 62% of the times when the values of sensor 17 increase beyond a threshold in the last section of the timeseries, these values contribute to decreasing the RUL. Armed with this rule, if sensor 17 generally displays high values above 393 for several previous cycles of an engine, then this is one of the contributing factors of a reduced RUL. Thus, the directly interpretable rule-based explainer 128 may perform an action of investigating the engine subsection associated with sensor 17.

In FIG. 13, the directly interpretable rule-based explainer 128 explains that the impact of sensor 12's behavior on RUL is that sensor 12 generally displays values lower than a threshold (523) in the last section of the timeseries. This is one of the contributing factors of a reduced RUL.

In FIG. 13, the directly interpretable rule-based explainer 128 explains that the joint impact of sensors 7 and 20's behavior on RUL is that, if sensors 7 and 20 together display values lower than their respective thresholds in the later part of the timeseries, then this is a contributing factor of a reduced RUL.

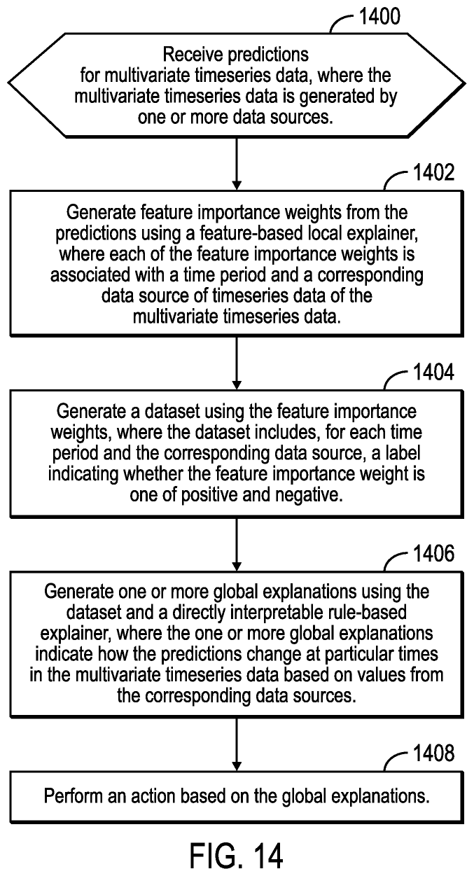

FIG. 14 illustrates, in a flowchart, operations performed by a global context explainer 120 in accordance with certain embodiments. Control begins at block 1400 with the global context explainer 120 receiving predictions for multivariate timeseries data, where the multivariate timeseries data is generated by one or more data sources. In block 1402, the global context explainer 120 generates feature importance weights from the predictions using a feature-based local explainer, where each of the feature importance weights is associated with a time period and a corresponding data source (of the one or more data sources) of timeseries data of the multivariate timeseries data. In block 1404, the global context explainer 120 generates a dataset using the feature importance weights, where the dataset includes, for each time period and the corresponding data source, a label indicating whether the feature importance weight is one of positive and negative.

In block 1406, the global context explainer 120 generating one or more global explanations using the dataset and a directly interpretable rule-based explainer, where the one or more global explanations indicate how the predictions change at particular times in the multivariate timeseries data based on values from the corresponding data sources. In block 1408, the global context explainer 120 performs an action based on the global explanations. In certain embodiments, multiple actions may be performed.

Embodiments help make machine learning models more interpretable and trustworthy. Embodiments fuse two explainers (i.e., machine learning models) in sequence, where the explanations output by the first explainer are explained by the second explainer. Embodiments build the global context explainer 120 as a two-stage global post-hoc explainer for multivariate timeseries models that fuses a feature-based local explainer (a first stage that outputs feature importance weights) with a directly interpretable rule-based explainer (a second stage that outputs global explanations). With embodiments, the global explanations shed light on how the behavior of individual sensors and groups of sensors impact the remaining useful life of an aircraft's engine. Based on these global explanations, the global context explainer 120 performs an action.

Embodiments allow enterprises to harnessing the full potential of deep learning models by meaningfully explaining their inner workings and predictions to stakeholders. The consequence of this opacity is an increase in both user trust of predictions and the overall usefulness of an application that deploy these models. Embodiments are able to provide different stakeholders (e.g., domain practitioners, model developers, regulators, and impacted users) different types of explanations.

In certain embodiments, the hyper parameters of the two explainers are tuned in order to optimize the final output. For example, parameters that control the length of a rule (of a global explanation 174), as well as, the total number of rules that define a source ML model 110 may be tuned so that given a large group of data sources (e.g., sensors), embodiments may extract meaningful rules involving individual data sources or a subset of data sources.

In certain embodiments, there is an automatic search for different combinations of explainers to find an optimal combination based on the faithfulness or length of the final rules.

Embodiments produce global context explanations for multivariate timeseries AI models (that occur in numerous domains such as healthcare, finance, e-commerce, Information Technology (IT), social media, Internet of Things (IoT), etc.). Embodiments take as input the original train and test datasets, along with a source ML model Application Programming Interface (API)). Embodiments compute global context explanations that explain the behavioral impact of each timeseries on the predictions output by the source ML model. Embodiments also compute global context explanations that explain the joint behavioral impact of pairs or groups of timeseries on the prediction output by the source ML model.

Embodiments fuse multiple explainers in a pipeline to produce the global context explanations for multivariate timeseries AI model. In the first stage, the feature-based local explainer 122 produces feature importance weights. The inputs of the feature-based local explainer 122 are an original train and test datasets, along with blackbox AI model (e.g., the API of the AI model) that uses multivariate timeseries data.

In the second stage, the dataset formulator 124 formulates a supervised ML problem (as a dataset 174) based on the time, the multivariate timeseries data, and the feature importance weights produced for the samples in the train dataset. For the supervised ML problem, the features include time and values of the multivariate timeseries. The label may include the feature importance weight produced by the local explainer or its function for instance, along with a binary value based on positive or negative feature importance weight.

In the third stage, the directly interpretable rule-based explainer 126 outputs global explanations 174 for the supervised ML problem. The global explanations 174 explain how the prediction changes based on time and value of each timeseries.

In the fourth stage, the action implementor 128 performs an action based on the output global explanations 174.

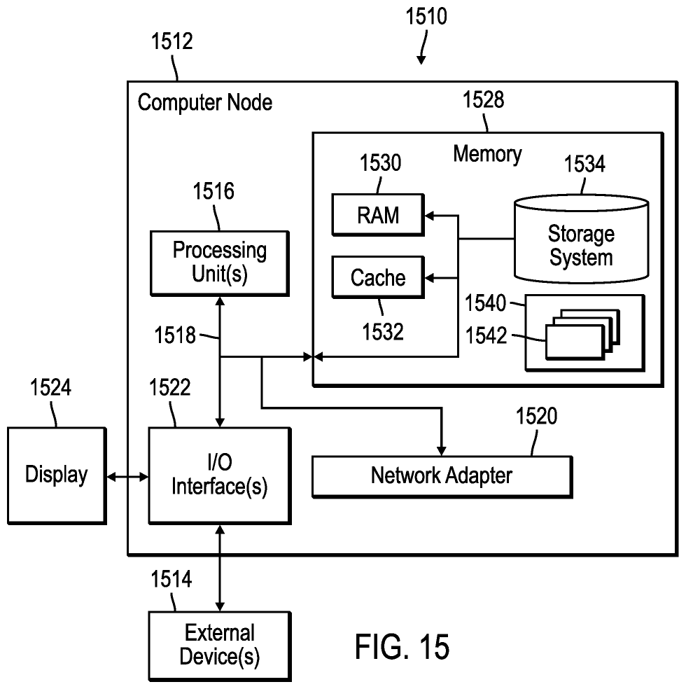

FIG. 15 illustrates a computing environment 1510 in accordance with certain embodiments. In certain embodiments, the computing environment is a cloud computing environment. Referring to FIG. 15, computer node 1512 is only one example of a suitable computing node and is not intended to suggest any limitation as to the scope of use or functionality of embodiments of the invention described herein. Regardless, computer node 1512 is capable of being implemented and/or performing any of the functionality set forth hereinabove.

The computer node 1512 may be a computer system, which is operational with numerous other general purpose or special purpose computing system environments or configurations. Examples of well-known computing systems, environments, and/or configurations that may be suitable for use with computer node 1512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer node 1512 may be described in the general context of computer system executable instructions, such as program modules, being executed by a computer system. Generally, program modules may include routines, programs, objects, components, logic, data structures, and so on that perform particular tasks or implement particular abstract data types. Computer node 1512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 15, computer node 1512 is shown in the form of a general-purpose computing device. The components of computer node 1512 may include, but are not limited to, one or more processors or processing units 1516, a system memory 1528, and a bus 1518 that couples various system components including system memory 1528 to one or more processors or processing units 1516.

Bus 1518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer node 1512 typically includes a variety of computer system readable media. Such media may be any available media that is accessible by computer node 1512, and it includes both volatile and non-volatile media, removable and non-removable media.

System memory 1528 can include computer system readable media in the form of volatile memory, such as random access memory (RAM) 1530 and/or cache memory 1532. Computer node 1512 may further include other removable/non-removable, volatile/non-volatile computer system storage media. By way of example only, storage system 1534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a compact disc read-only memory (CD-ROM), digital versatile disk read-only memory (DVD-ROM) or other optical media can be provided. In such instances, each can be connected to bus 1518 by one or more data media interfaces. As will be further depicted and described below, system memory 1528 may include at least one program product having a set (e.g., at least one) of program modules that are configured to carry out the functions of embodiments of the invention.

Program/utility 1540, having a set (at least one) of program modules 1542, may be stored in system memory 1528 by way of example, and not limitation, as well as an operating system, one or more application programs, other program modules, and program data. Each of the operating system, one or more application programs, other program modules, and program data or some combination thereof, may include an implementation of a networking environment. Program modules 1542 generally carry out the functions and/or methodologies of embodiments of the invention as described herein.

Computer node 1512 may also communicate with one or more external devices 1514 such as a keyboard, a pointing device, a display 1524, etc.; one or more devices that enable a user to interact with computer node 1512; and/or any devices (e.g., network card, modem, etc.) that enable computer node 1512 to communicate with one or more other computing devices. Such communication can occur via Input/Output (I/O) interfaces 1522. Still yet, computer node 1512 can communicate with one or more networks such as a local area network (LAN), a general wide area network (WAN), and/or a public network (e.g., the Internet) via network adapter 1520. As depicted, network adapter 1520 communicates with the other components of computer node 1512 via bus 1518. It should be understood that although not shown, other hardware and/or software components could be used in conjunction with computer node 1512. Examples, include, but are not limited to: microcode, device drivers, redundant processing units, external disk drive arrays, Redundant Array of Inexpensive Disks (RAID) systems, tape drives, and data archival storage systems, etc.

In certain embodiments, the computing device 100 has the architecture of computer node 1512. In certain embodiments, the computing device 100 is part of a cloud infrastructure. In certain alternative embodiments, the computing device 100 is not part of a cloud infrastructure.

### Cloud Embodiments

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

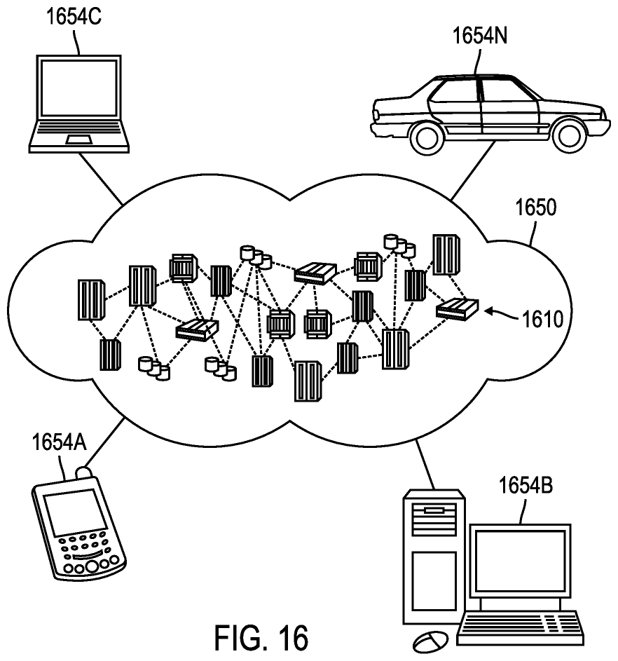

Referring now to FIG. 16, illustrative cloud computing environment 1650 is depicted. As shown, cloud computing environment 1650 includes one or more cloud computing nodes 1610 with which local computing devices used by cloud consumers, such as, for example, personal digital assistant (PDA) or cellular telephone 1654A, desktop computer 1654B, laptop computer 1654C, and/or automobile computer system 1654N may communicate. Nodes 1610 may communicate with one another. They may be grouped (not shown) physically or virtually, in one or more networks, such as Private, Community, Public, or Hybrid clouds as described hereinabove, or a combination thereof. This allows cloud computing environment 1650 to offer infrastructure, platforms and/or software as services for which a cloud consumer does not need to maintain resources on a local computing device. It is understood that the types of computing devices 1654A-N shown in FIG. 16 are intended to be illustrative only and that computing nodes 1610 and cloud computing environment 1650 can communicate with any type of computerized device over any type of network and/or network addressable connection (e.g., using a web browser).

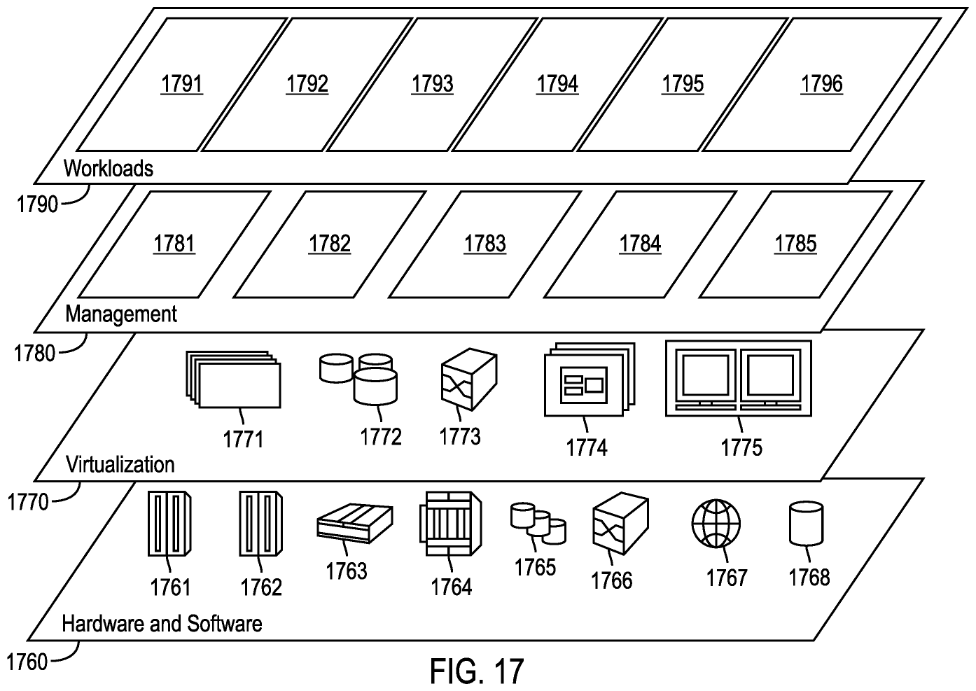

Referring now to FIG. 17, a set of functional abstraction layers provided by cloud computing environment 1650 (FIG. 16) is shown. It should be understood in advance that the components, layers, and functions shown in FIG. 17 are intended to be illustrative only and embodiments of the invention are not limited thereto. As depicted, the following layers and corresponding functions are provided:
Hardware and software layer 1760 includes hardware and software components. Examples of hardware components include: mainframes 1761; RISC (Reduced Instruction Set Computer) architecture based servers 1762; servers 1763; blade servers 1764; storage devices 1765; and networks and networking components 1766. In some embodiments, software components include network application server software 1767 and database software 1768.

Virtualization layer 1770 provides an abstraction layer from which the following examples of virtual entities may be provided: virtual servers 1771; virtual storage 1772; virtual networks 1773, including virtual private networks; virtual applications and operating systems 1774; and virtual clients 1775.

In one example, management layer 1780 may provide the functions described below. Resource provisioning 1781 provides dynamic procurement of computing resources and other resources that are utilized to perform tasks within the cloud computing environment. Metering and Pricing 1782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1783 provides access to the cloud computing environment for consumers and system administrators. Service level management 1784 provides cloud computing resource allocation and management such that required service levels are met. Service Level Agreement (SLA) planning and fulfilment 1785 provide pre-arrangement for, and procurement of, cloud computing resources for which a future requirement is anticipated in accordance with an SLA.

Workloads layer 1790 provides examples of functionality for which the cloud computing environment may be utilized. Examples of workloads and functions which may be provided from this layer include: mapping and navigation 1791; software development and lifecycle management 1792; virtual classroom education delivery 1793; data analytics processing 1794; transaction processing 1795; and global context explainers for Artificial Intelligence (AI) systems using multivariate timeseries data 1796.

Thus, in certain embodiments, software or a program, implementing global context explainers for Artificial Intelligence (AI) systems using multivariate timeseries data in accordance with embodiments described herein, is provided as a service in a cloud environment.

### Additional Embodiment Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
receiving predictions for multivariate timeseries data;
generating feature importance weights from the predictions using a feature-based local explainer, wherein each of the feature importance weights is associated with a time period and a corresponding data source of timeseries data of the multivariate timeseries data;
generating a dataset using the feature importance weights, wherein the dataset includes, for each time period and the corresponding data source, a label indicating whether the feature importance weight is one of positive and negative;
generating one or more global explanations using the dataset and a directly interpretable rule-based explainer, wherein the one or more global explanations indicate how the predictions change at particular times in the multivariate timeseries data based on values from the corresponding data source; and
performing an action based on the global explanations.

2. The computer-implemented method of claim 1, wherein the predictions are received from a source Machine Learning (ML) model.

3. The computer-implemented method of claim 1, wherein the feature-based local explainer and the directly interpretable rule-based explainer comprise ML models that are fused in sequence.

4. The computer-implemented method of claim 1, wherein each of the one or more global explanations is for one or more data sources.

5. The computer-implemented method of claim 1, wherein the action comprises one of: modifying a data source, sending a notification, and scheduling maintenance.

6. The computer-implemented method of claim 1, wherein each of the one or more global explanations comprises a rule and a rule fidelity.

7. The computer-implemented method of claim 1, wherein a Software as a Service (SaaS) is configured to perform the operations of the computer-implemented method.

8. A computer program product, the computer program product comprising a computer readable storage medium having program code embodied therewith, the program code executable by at least one processor to perform operations for: receiving predictions for multivariate timeseries data;
generating feature importance weights from the predictions using a feature-based local explainer, wherein each of the feature importance weights is associated with a time period and a corresponding data source of timeseries data of the multivariate timeseries data;
generating a dataset using the feature importance weights, wherein the dataset includes, for each time period and the corresponding data source, a label indicating whether the feature importance weight is one of positive and negative;
generating one or more global explanations using the dataset and a directly interpretable rule-based explainer, wherein the one or more global explanations indicate how the predictions change at particular times in the multivariate timeseries data based on values from the corresponding data source; and
performing an action based on the global explanations.

9. The computer program product of claim 8, wherein the predictions are received from a source Machine Learning (ML) model.

10. The computer program product of claim 8, wherein the feature-based local explainer and the directly interpretable rule-based explainer comprise ML models that are fused in sequence.

11. The computer program product of claim 8, wherein each of the one or more global explanations is for one or more data sources.

12. The computer program product of claim 8, wherein the action comprises one of: modifying a data source, sending a notification, and scheduling maintenance.

13. The computer program product of claim 8, wherein each of the one or more global explanations comprises a rule and a rule fidelity.

14. The computer program product of claim 8, wherein a Software as a Service (SaaS) is configured to perform the operations of the computer program product.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
receiving predictions for multivariate timeseries data;
generating feature importance weights from the predictions using a feature-based local explainer, wherein each of the feature importance weights is associated with a time period and a corresponding data source of timeseries data of the multivariate timeseries data;
generating a dataset using the feature importance weights, wherein the dataset includes, for each time period and the corresponding data source, a label indicating whether the feature importance weight is one of positive and negative;
generating one or more global explanations using the dataset and a directly interpretable rule-based explainer, wherein the one or more global explanations indicate how the predictions change at particular times in the multivariate timeseries data based on values from the corresponding data source; and
performing an action based on the global explanations.

16. The computer system of claim 15, wherein the predictions are received from a source Machine Learning (ML) model.

17. The computer system of claim 15, wherein the feature-based local explainer and the directly interpretable rule-based explainer comprise ML models that are fused in sequence.

18. The computer system of claim 15, wherein each of the one or more global explanations is for one or more data sources.

19. The computer system of claim 15, wherein the action comprises one of: modifying a data source, sending a notification, and scheduling maintenance.

20. The computer system of claim 15, wherein a Software as a Service (SaaS) is configured to perform the operations of the computer system.
